(19) United States
(12) Patent Application Publication
(10) Pub. No.: US 2004/0249751 A1
(43) Pub. Date: Dec. 9, 2004

(54) Method for the authorization of payments in a communication network

(76) Inventor: Karsten Luttge, Berlin (DE)

Correspondence Address: MORRISON & FOERSTER LLP, 1650 TYSONS BOULEVARD, SUITE 300, MCLEAN, VA, 22102, US

(21) Appl. No.: 10/492,636

(22) PCT Filed: Oct. 8, 2002
(86) PCT No.: PCT/DE02/03853

(30) Foreign Application Priority Data
Oct. 15, 2001 (DE) 10151213.9

(51) Int. Cl. G06F 17/60

(52) U.S. Cl. 705/40

(57) ABSTRACT

The invention relates to a method for the authorization of payments in a communication network. According to said method, when a pay service is requested by a communication terminal of a service user, an authorization message is sent to a payment service provider by said communication terminal, authorizing payment for said service. An individual authorization ID is stored by the payment service provider in a memory, the authorization ID is sent to the service provider device, a payment request message containing the authorization ID is sent to the payment service provider, and the payment is recognized as authorized by the payment service provider if the authorization ID of the payment request message is available in the memory.

### CLAIM FOR PRIORITY

This application claims priority to International Application No. PCT/DE02/03853, which was published in the German language on May 1, 2003, which claims the benefit of priority to German Application No. 101 51 213.9 which was filed in the German language on Oct. 15, 2001.

### TECHNICAL FIELD OF THE INVENTION

The invention relates to a method for approving payments in a communication network.

### BACKGROUND OF THE INVENTION

As “E-Commerce” becomes increasingly established, chargeable services (e.g. supply of information, data or goods) are provided over communication networks more and more frequently. Communication networks of this type which are used are the Internet or telecommunication networks (mobile radio network, landline networks), for example. Paying for the services requires methods for “mobile payment” or “Internet payment”, for example. “Mobile payment” means cashless payment on the move using the mobile phone, and “Internet payment” means cashless payment for services which are obtained or at least ordered over the Internet.

Smaller service providers, in particular, do not perform the relatively complex payment operations themselves, but rather use the assistance of payment service providers. Such payment operations thus generally involve a service user (consumer), a service provider (merchant) and the payment service provider. In this context, it is necessary to ensure, in particular, that prior to the performance of a payment operation by the payment service provider this payment operation is approved (authorized) by the service user (payment authorization).

### SUMMARY OF THE INVENTION

It present invention discloses a method which allows a service user to approve payments needing to be organized by a payment service provider in a simple and reliable manner.

In one embodiment of the invention, there is a method for approving payments in a communication network in which a request from a communication terminal belonging to a service user for a service which requires a payment is followed by

a service provider facility associated with the service transmitting a communication address for a payment service provider to the communication terminal,

the communication terminal approving a payment which relates to the service by transmitting an approval message to the payment service provider,

the payment service provider then storing an individual approval identifier in a memory,

the approval identifier being transmitted to the communication terminal,

the communication terminal transmitting the approval identifier to the service provider facility,

the service provider facility then sending a payment request message which contains the approval identifier to the payment service provider, and

the payment service provider identifying the payment as having been approved if the approval identifier in the payment request message is present in the memory.

In this context, the approval message is advantageously transmitted to the payment service provider before the payment service provider receives the payment request message from the service provider facility. The payment service provider can therefore make the payment very quickly after the payment request message arrives, provided that a memory check which it can perform easily and quickly shows that the appropriate approval identifier exists in its memory.

In another embodiment of the invention, the service provider facility transmits the communication address together with payment information to the communication terminal,

the communication terminal then transmits an approval start message to the payment service provider,

the payment service provider requests approval action from the service user, and

when approval action has been taken the communication terminal creates the approval message.

A particular advantage in this context is that the contact between the communication terminal and the payment service provider is set up on the initiative of the communication terminal (approval start message). This is in accordance with the security interests of the service user, who often does not wish to be contacted with regard to the payment by a payment service provider which is initially not known to him.

In another embodiment of the invention, the approval action is requested from the service user by virtue of

the payment service provider transmitting display data to the communication terminal which display at least some of the payment information on a display on the communication terminal and which ask the service user to operate a control element on the communication terminal.

Advantageously, this transmission and display by the communication terminal can involve the use of means and methods which are available on the communication terminal anyway for carrying out “E-commerce” methods. Thus, the communication with a communication terminal in the form of a mobile telephone can be effected, by way of example, using a communication protocol called “Wireless Application Protocol” (WAP). Today, modern mobile telephones are able and have an apparatus (a “WAP browser”) to display data and messages transmitted by WAP in order to use the WAP protocol.

Using a communication terminal in the form of a computer which is connected to the Internet, the communication can be effected, by way of example, using a communication protocol called “Hypertext Transfer Protocol” (HTTP)—which is a communication protocol used as standard on the Internet. Computers which are connected to the Internet have “web browsers” available to display data and messages transmitted by HTTP.

To implement the invention, there is therefore advantageously no need to make complex extensions or upgrades on communication terminals, which means that the invention can be carried out in a particularly easy, service user-friendly and inexpensive manner.

The invention allows approval data to be stored in the memory together with the approval identifier. It is thus advantageously possible for the payment service provider to store further information about the approval which has been granted.

The invention described up to now allows the approval data stored in the memory to be an expiry time and allows the payment service provider to identify the payment as having been approved if the expiry time for the approval identifier stored in the memory has not been exceeded.

This advantageously allows the security of the method to be increased, since payment request messages arriving late (which may be based on approval identifiers or manipulated data transmissions intercepted, without authorization, from stations which are not involved in the method, which can delay the arrival of the payment request messages) can be identified and supplied to a special handling facility.

### BRIEF DESCRIPTION OF THE DRAWINGS

The invention is described below in more detail with reference to the exemplary drawings, in which:

FIG. 1 shows an exemplary embodiment of the invetion.

FIG. 2 shows message flows in an exemplary embodiment of the invention.

### DETAILED DESCRIPTION OF THE INVENTION

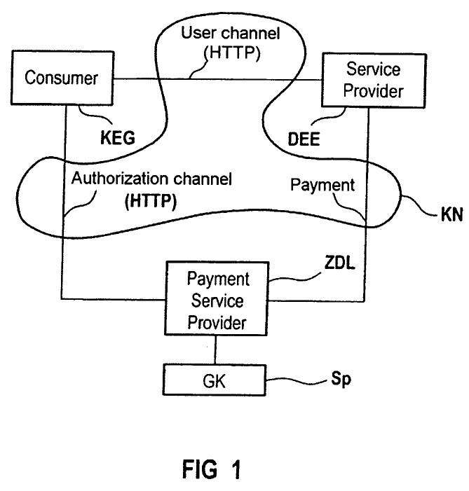

FIG. 1 shows a communication terminal KEG belonging to a service user, a service provider facility DEE and a payment service provider ZDL.

In the exemplary embodiment shown for the method, dialogs for payment authorization (payment approval) are held on the Internet using the WWW (World Wide Web) technology, i.e. using the Hypertext Transfer Protocol (HTTP) and a suitable markup language (e.g. hypertext markup language HTML). The method can be used particularly advantageously when the service requiring a payment is provided using WWW technology, i.e. when the service is implemented on an HTTP server and uses HTTP and HTML for communicating with the service user (consumer). In this case, the service user can also use the facilities and programs (e.g. an HTML browser) which it uses to request services for the purpose of approving payments.

The service user can thus use the HTML browser which he normally uses in order to access the service provider facility's service. The service provider (merchant) uses an HTTP server, such as Apache or Microsoft IIS, in the service provider facility in order to provide the service which requires the payment. Between the two, there is a connection (denoted by “user channel” in the figure) which has been set up using the HTTP protocol; such a connection is also called a “virtual connection”. This connection is set up using a communication network KN which uses the Internet protocol (IP) (“is based on the Internet protocol (IP)”). Using this connection, the merchant uses HTTP to provide the service requiring a payment, said service involving the delivery of data (such as messages or stock market prices), for example.

The payment service provider uses a system which likewise includes an HTTP server. Between this HTTP server and the consumer there is likewise a (virtual) connection which is set up using the IP-based communication network KN; to implement this connection, the protocol HTTP is likewise used. This connection is denoted by “authorization channel” in the figure. This connection is used to execute the authorization dialog (approval dialog) between the communication terminal and the payment service provider.

The payment service provider's system communicates with the system (service provider facility) belonging to the service provider via a (virtual) connection, labeled by “payment” in the figure. The service provider facility uses this connection to send payment request messages (payment requests) to the payment service provider. This connection can be provided in any manner using the communication network KN (as shown in the figure) or else without using the communication network KN. This can be done using “Parlay content based charging API” for example.

If the method illustrated above in connection with FIG. 1 is intended to be used in conjunction with mobile communication networks (e.g. GSM networks; GSM=Global System for Mobile Communication), then the basic procedure requires no changes. It then merely involves the use, in a similar manner to what has been said up to now, of a “Wireless Application Protocol” (WAP) instead of the HTTP protocol, of a page description language called “wireless markup language” (WML) instead of the language HTML, and a WAP browser and a WAP server instead of the HTTP browser and the HTTP server.

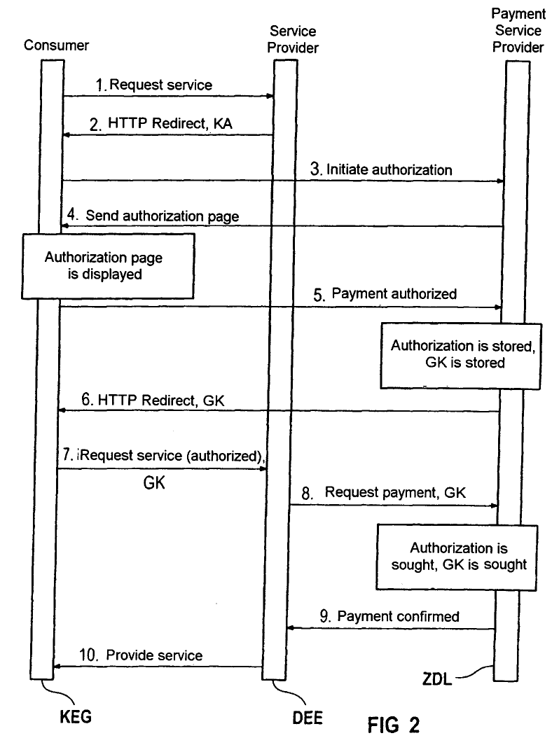

The payment service provider ZDL has a memory Sp (e.g. a database) in which, inter alia, an approval identifier GK is stored in the course of the method and is sought again later. This is described in detail in conjunction with FIG. 2.

FIG. 2 shows message flows between the service user's communication terminal KEG, the service provider's service provider facility DEE and the payment service provider ZDL. This is done using a WEB browser in the service user's communication terminal, an HTTP server in the service provider facility DEE and a second HTTP server with the payment service provider. The procedure is explained for a web browser; the procedure for a WAP browser is of a corresponding nature.

To prepare to use the service, the service user first starts the browser on his communication terminal. The service user calls up an address (the URL=Uniform Resource Locator) for the service provider and is initially presented with a service selection (not shown in the figure) in his browser. The service user selects a service or goods from his browser and clicks on said service or goods. The browser then sends a message in the form of an HTTP-GET request to the HTTP server belonging to the service provider (merchant). The HTTP-GET request (arrow 1 “Request service”) includes the service user's selection (for example a piece of information which he requires and therefore orders). This means that the service user's communication terminal requests from the service provider a service which requires a payment and there is a request for the service in the service provider facility.

The HTTP server belonging to the service provider (i.e. the DEE) identifies that the service or the goods (in this case: the piece of information) is/are chargeable and starts authorization (approval) of the payment. It does this using the “Redirect” method in the HTTP protocol. HTTP Redirect is a method which is part of the HTTP protocol and is therefore supported by any HTTP server and also by any browser. In this method, an HTTP server A does not directly send the requested piece of information in response to a request message (e.g. a GET request). Instead, the HTTP server A responds with a “Redirect” message, i.e. a reference to another HTTP server B. In this case, the HTTP server A expects the service user's browser to send a new request message to the HTTP server B automatically, i.e. without any action by the service user. In the “Redirect” message, the HTTP server A can additionally transmit information which needs to be transmitted to the HTTP server B together with the new request message. Since the method is described exactly in the HTTP protocol, the browser can interpret the “Redirect” message and will behave in the manner expected by the HTTP server A. In the exemplary embodiment, the service provider's HTTP server undertakes role “A” and the payment service provider's HTTP server undertakes role “B”.

To this end, the service provider's HTTP server responds to the HTTP-GET request with a message in the form of an “HTTP Redirect” (arrow 2) to the communication terminal KEG. This HTTP message includes, in the form of “payment information”, the information which the service user requires to authorize the payment, e.g. price, designation of the goods, identification of the trader, and also a communication address KA for the payment service provider (URL for the payment service provider) as a “destination” for the Redirect.

The service user's browser interprets the “HTTP Redirect” in line with the HTTP protocol specification, i.e. it automatically generates a new HTTP-GET request and sends it (arrow 3 “Initiate authorization”) to the payment service provider's HTTP server. In this context, this new HTTP-GET request (arrow 3 “Initiate authorization”) forms an approval start message. The “payment information” which the browser has received in the “HTTP Redirect” message (arrow 2) is included in this case, that is to say the HTTP-GET request (arrow 3) also includes the payment information. This operation is normally invisible to the service user.

The payment service provider's HTTP server evaluates the HTTP-GET request. From the information received (e.g. the payment information), it generates an HTML document which contains a request for an approval action and thus comprises an “authorization dialog” for the service user. The document thus contains the information which is relevant to the service user, e.g. price, designation of the goods, identification of the trader. In addition, the HTML document includes two buttons (“pushbuttons” on the communication terminal's display): “Accept” and “Reject”. The HTML page asks the consumer (service user) to operate the “Accept” button as an approval action for the purposes of approval, which the consumer can do by operating control elements on the communication terminal.

This HTML page is sent to the consumer's browser (arrow 4 “Send authorization page”) as a response to the approval start message (arrow 3).

The browser displays the HTML document on a display on the communication terminal. The service user checks the information. If it is correct, he operates the “Accept” button. The browser sends this information using an HTTP-GET request to the payment service provider's HTTP server (arrow 5 “Payment authorized”), and this message is an approval message for the payment service provider.

The payment service provider's HTTP server stores the approval message as confirmation of payment in a memory SP (see FIG. 1) and gives it a suitable expiry date (expiry time) which indicates how long the approval is valid for the payment. It generates an approval identifier GK (an identification number for the confirmation of payment) and also stores this in the memory Sp. The payment service provider's HTTP server in turn responds to the GET request (arrow 5) with an HTTP Redirect to the communication terminal KEG and in so doing includes the following information: the approval identifier GK and the URL of the service provider as a destination for the Redirect (arrow 6 “HTTP Redirect”); the merchant's URL was a communication address for the service provider facility DEE.

The browser in the service user's communication terminal interprets the HTTP Redirect in line with the HTTP specification, i.e. it automatically sends a new HTTP-GET request (arrow 7 “Request service (authorized)”) to the merchant's HTTP server. This involves transmitting the approval identifier GK to the merchant.

The service provider's HTTP server identifies from the approval identifier GK that the payment has already been authorized. It now asks the payment service provider to initiate the payment (arrow 8 “Request payment”); the approval identifier GK is included in this.

The payment service provider now checks whether the service user is in agreement with the payment and has approved it. To do this, it checks the confirmations of payment which are stored in its memory. If it finds a confirmation of payment with the approval identifier transmitted with the payment request message (arrow 8), and its expiry time has not yet been reached, the payment is made and this is confirmed to the service provider (arrow 9 “Payment confirmed”).

Since the payment operation has been successful, the service provider's HTTP server sends a response message (arrow 10 “Provide service”) to the communication terminal. This response message relates to the HTTP-GET request, which has been symbolized by arrow 7. This response message can actually be the requested service if the service is a supply of information, for example. If, in another example, the service is the delivery of consumer goods, then the response message includes information about the imminent delivery of the goods, for example.

The invention has many advantages:

The invention requires no specific software with the service user. The standard web or WAP browser, which is used anyway to access the service, is also used for the authorization dialog. This increases acceptance with the service user.

The invention retains the restriction provided in the HTTP protocol for security reasons that a web browser does not accept incoming connections. For this reason, setup of the authorization dialog is not initiated by the PSP's HTTP server, but rather the HTTP Redirect method is used in the inventive method so that the consumer's web browser can initiate this dialog.

A user perceives the authorization dialog (the part of the approval method which he can “see”) as part of the service. The Redirect to the payment service provider cannot be seen by him directly.

When the invention is used on the Internet, the use of a mobile telephone is not necessary. This means that the method may also be used by consumers who do not have a mobile telephone or when ambient conditions (e.g. screening of electromagnetic waves) prevent the use of a mobile telephone.

When the invention is used on the Internet, no additional charges are incurred. Internet access is necessary anyway in order to use the services and brings about no further costs for the authorization dialog; in particular, no costs are incurred for mobile telephone connections.

The invention can be implemented easily and very inexpensively, since no complex additional equipment is necessary for the invention at the communication terminal end, and the service provider and the payment service provider also essentially require only HTTP or WAP servers which are relatively easy to implement.

The method for approving payments can readily be combined with standardized payment methods, particularly with “Parlay content based charging” or “3GPP OSA content charging”. Further information about Parlay technology can be found on the Internet at the Internet address www.parlay.org.

1. A method for approving payments in a communication network in which a request from a communication terminal belonging to a service user for a service which requires a payment, comprising:
transmitting a communication address for a payment service provider to the communication terminal, via a service provider facility associated therewith;
approving, via the communication terminal, a payment which relates to the service by transmitting an approval message to the payment service provider;
storing, via the payment service provider, an individual approval identifiers in a memory;
transmitting the approval identifier to the communication terminal;
transmitting, via the communication terminal, the approval identifiers to the service provider facility;
sending, via the service provider facility, a payment request message which includes the approval identifier to the payment service provider; and
identifying, via the payment service provider, the payment as having been approved if the approval identifier in the payment request message is present in the memory.

2. The method as claimed in claim 1,
further comprising:
transmitting, via the service provider facility, the communication address with payment information to the communication terminal;
transmitting, via the communication terminal, an approval start message to the payment service provider;
requesting, via the payment service provider, approval action from the service user; and
creating the approval message when approval action has been taken the communication.

3. The method as claimed in claim 2,
wherein
the approval action is requested from the service user by
the payment service provider transmitting display data to the communication terminal, which displays at least some of the payment information on a display on the communication terminal and which requests the service user to operate a control element on the communication terminal.

4. The method as claimed in claim 1, wherein
the communication with the communication terminal is effected using a Hypertext Transfer Protocol.

5. The method as claimed in claim 4,
wherein
the transmission of the approval start to the payment service provider is initiated by an HTTP server in the service provider facility using a Redirect operation in the Hypertext Transfer Protocol.

6. The method as claimed in claim 1, wherein
the communication with the communication terminal is effected using a Wireless Application Protocol.

7. The method as claimed in claim 1, wherein
approval data are stored in the memory together with the approval identifier.

8. The method as claimed in claim 7,
wherein
the approval data stored in the memory are service-specific data, price data, currency data or identity data for the service user or for a service provider.

9. The method as claimed in claim 7,
wherein
the approval data stored in the memory are an expiry time, and
the payment service provider identifies the payment as having been approved the expiry time for the approval identifier stored in the memory has not been exceeded.
